(19) United States
(12) Patent Application Publication
(10) Pub. No.: US 2023/0106078 A1
(43) Pub. Date: Apr. 6, 2023

(54) METHOD OF MANUFACTURING A BRINELLING-RESISTANT HUB BEARING UNIT

(71) Applicant: AKTIEBOLAGET SKF, GOTEBORG (SE)

(72) Inventors: David Christopher Rybski, White Lake, MI (US); Michele Musso, South Lyon, MI (US); Fernando Juarez, Puebla (MX)

(21) Appl. No.: 17/495,253

(22) Filed: Oct. 6, 2021

(51) Int. Cl. B21D 53/10; F16C 19/18

(52) U.S. Cl. CPC B21D 53/10; F16C 19/184; F16C 2326/02

(57) ABSTRACT

A method of manufacturing a wheel hub bearing unit includes providing a bearing ring having at least one raceway surface, the bearing ring preferably being a bearing outer ring which is preferably formed of a steel having a carbon content of between about 0.55% by weight and 0.60% by weight. The bearing ring is carbonitrided within a furnace having an enclosed atmosphere containing ammonia gas. The bearing ring is then tempered by heating the ring to at least five hundred degrees Celsius (500° F.). Next, the induction hardening the at least one raceway surface of the ring is induction hardened, preferably by means of special inductor coil. Finally, the raceway surface(s) of the ring is machined to desired final dimensions and surface finish.

### BACKGROUND OF THE INVENTION

The present invention relates to bearings, and more particularly to hub bearing units.

Hub bearing units are well known and are used to rotatably couple the wheels to a vehicle. A hub bearing unit typically comprises an inner ring connected with an axle or shaft and an outer ring connected with the vehicle frame (i.e., through a steering knuckle and/or suspension) or with an axle, one of the two rings being rotatable about a central axis and the other ring being fixed (i.e., non-rotatable). The two bearing rings are coupled by at least one and typically two sets of rolling elements, and a wheel is mounted to the rotatable ring.

During use of the vehicle, impacts to the wheel are often transferred to the rolling elements through the ring connected with the wheel. Such impacts may cause the rolling elements to indent the raceway surfaces on which the elements roll, which can lead to vibration or chattering of the bearing and ultimately galling or spalling of the raceways. Although certain devices and bearing structures have been developed to limit brinelling, these have had limited success in preventing brinelling of the bearing inboard raceways.

### SUMMARY OF THE INVENTION

In one aspect, the present invention is a method of manufacturing a wheel hub bearing unit, the method comprising the steps of: providing a bearing ring having at least one raceway surface; carbonitriding the bearing ring; tempering the bearing ring; induction hardening the at least one raceway surface of the ring; and finish machining the raceway surface of the ring to desired final dimensions and surface finish.

In another aspect, the present invention is again method of manufacturing a wheel hub bearing unit, the method comprising the steps of: providing a bearing ring having at least one raceway surface, the bearing ring being formed of a steel having a carbon content of between about 0.55% by weight and 0.60% by weight; carbonitriding the bearing ring within a furnace having an enclosed atmosphere containing ammonia gas; tempering the bearing ring by heating the bearing ring to at least four hundred eighty degrees Celsius (480° C.); induction hardening the at least one raceway surface of the ring; tempering the bearing ring a second time at temperature no greater than three hundred degrees Celsius (300° C.); and machining the at least one raceway surface of the ring to desired final dimensions and surface finish.

In a further aspect, the present invention is a wheel hub bearing unit comprising a bearing inner ring and a bearing outer ring. At least one of the bearing rings is formed of a medium carbon steel and has at least one raceway surface, the ring being carbonitrided and the at least one raceway surface being induction hardened after carbonitriding the ring. A plurality of rolling elements rotatably couple the bearing inner ring with the bearing outer ring.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of an example hub bearing unit with a bearing outer ring formed in accordance with the present invention;

FIG. 2 is an axial cross-sectional view of an example bearing outer ring formed in accordance with the present invention;

FIG. 3 is a flow diagram of the basic manufacturing process of the present invention; FIG. 4 is a flow diagram of a preferred carbonitriding process of the present manufacturing process;

FIG. 5 is a time-temperature graph of the heat treatment steps of the present manufacturing process

FIG. 6 is a more diagrammatic depiction of a furnace used in the carbonitriding process;

FIG. 7 is an axial cross-sectional view of the example bearing outer ring indicating certain dimensions for final machining; and

FIG. 8 is an enlarged, broken-away axial cross-sectional view of the bearing outer ring, showing an example induction heating coil.

### DETAILED DESCRIPTION OF THE INVENTION

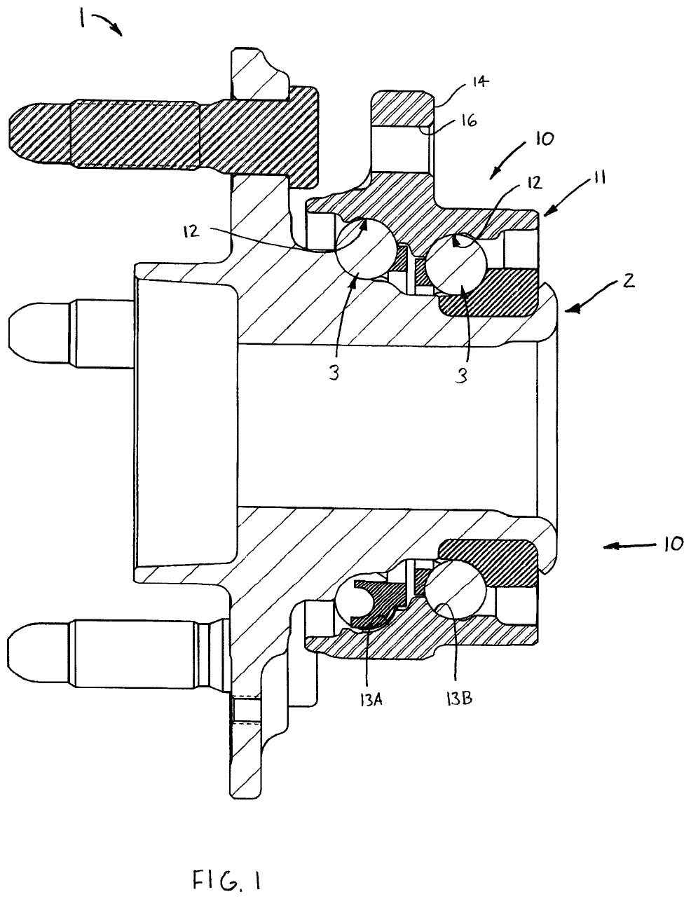

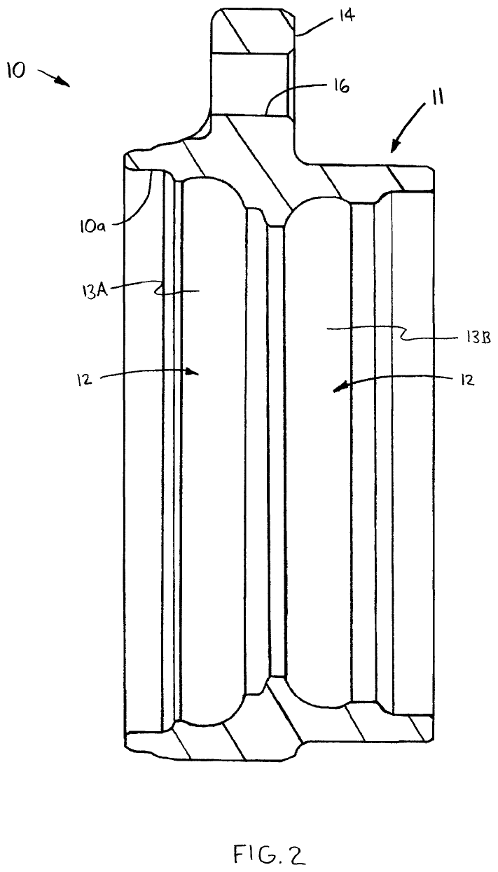

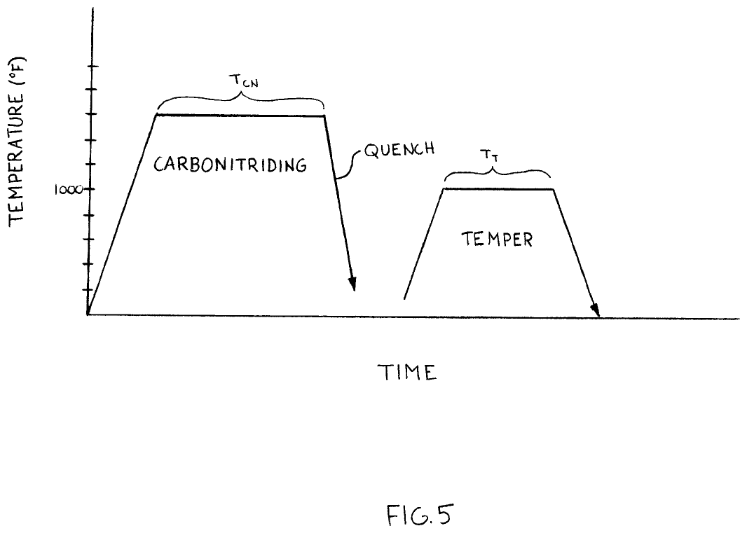

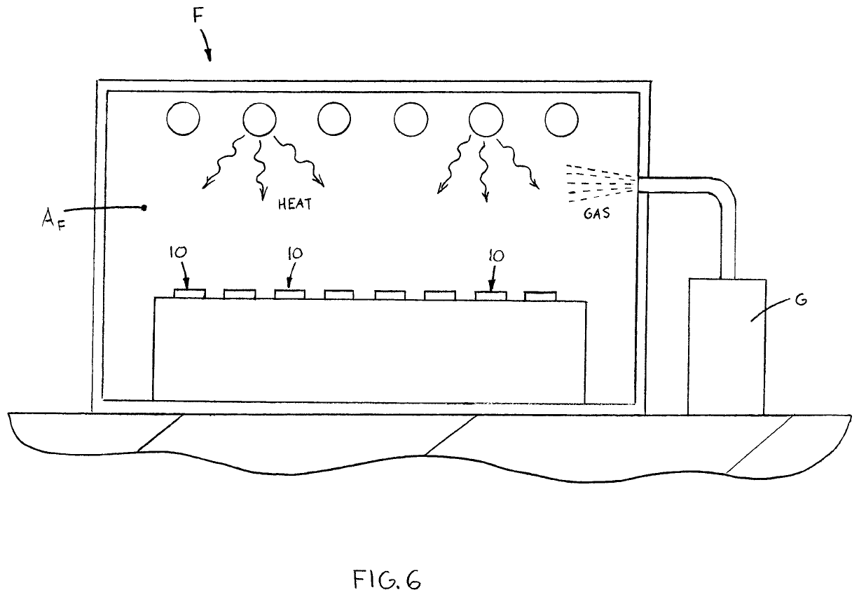

Referring now to the drawings in detail, wherein like numbers are used to indicate like elements throughout, there is shown in FIGS. 1-8 a method of manufacturing a hub bearing unit 1, and particularly at least one bearing ring 10 of the hub bearing unit 1 and most preferably at least a bearing outer ring 11, so as provide a substantial increase in brinelling resistance and/or fretting wear resistance. Such a hub bearing unit 1 (FIG. 1) is used to rotatably couple a wheel with a vehicle frame and/or a shaft and includes an inner ring 2, the outer ring 11 and at least one and preferably two sets of rolling elements 3. Although the drawings primarily depict a bearing outer ring 11 configured to connect to a vehicle frame (not shown), preferably through a steering knuckle and/or suspension (neither shown), the outer ring 10 may alternatively be configured to connect with a rotatable shaft and to receive a wheel or the bearing ring 10 may be a bearing inner ring 2. In any case, the manufacturing method of the present invention basically comprises the following steps:

1) providing a bearing ring 10 having at least one raceway surface 12;

2) carbonitriding the bearing ring 10;

3) tempering the bearing ring 10;

4) induction hardening the raceway surface(s) 12 of the bearing ring 10; and

5) finish machining the raceway surface(s) 12 of the bearing ring 10 to desired final dimensions and surface finish.

Preferably, the manufacturing process further includes quenching the bearing ring 10 after the carbonitriding step, specifically using oil, until the temperature of the ring 10 is reduced to about ninety degrees Celsius (90° C.). As discussed in further detail below, fabricating a bearing ring 10 using the present method provides a bearing unit 1 with raceway surface(s) 12 having a substantially increased resistance to brinelling and also to fretting wear.

More specifically, the basic bearing ring 10 is preferably provided as a forging of medium carbon steel, which is preferably formed of a steel having a carbon content of between about 0.55% by weight and 0.60% by weight, most preferably grade 55 LS (low sulfur) steel. However, the ring 10 may be formed of any other appropriate steel of any desired carbon content. In any case, the present process of both carbonitriding and induction hardening a bearing ring 10 formed of medium carbon steel is believed to be unknown in the bearing industry.

Preferably, the forged bearing ring 10 is formed having an inner circumferential surface 10a with two grooves for providing two raceway surfaces 12, specifically an outboard race 13A and an inboard race 13B, but may include only a single raceway surface 12 or three or more raceway surfaces 12 (neither alternative shown). The raceway surfaces 12 may be formed for any desired type of rolling elements, such as balls (as shown), cylindrical rollers, tapered rollers, needles, etc. and may be configured for the same type or any combination of types of rolling elements. Prior to any heat treatment, the bearing ring 10 is “rough machined”, in particular, certain dimensions of the bearing ring 10 are machined to approximate desired final dimensions, such as the axial length of the ring 10, ring outside diameter, the outside diameter of one or more mounting flange(s) 14, the inside diameter of the flange mounting holes 16, etc.

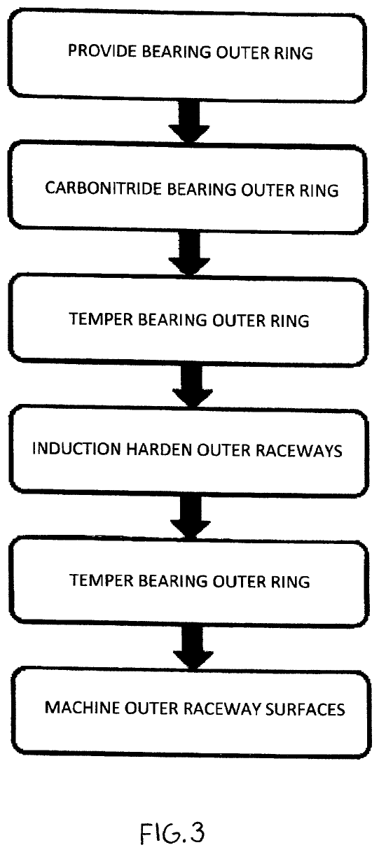

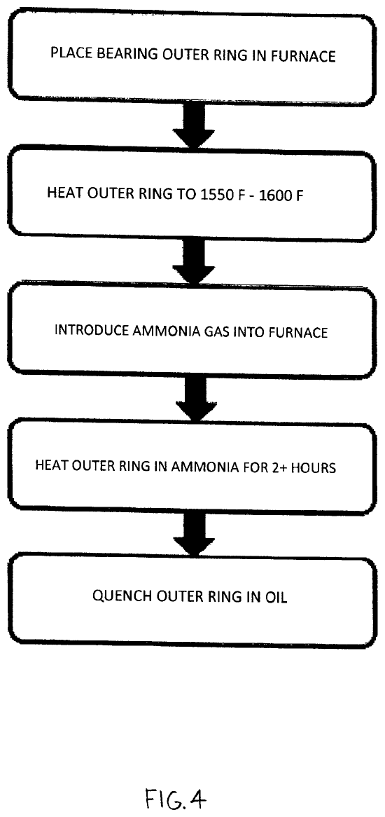

Referring to FIGS. 3-6, the preferred carbonitriding process occurs generally as follows. First, the bearing ring 10 is placed within a furnace F containing an enclosed atmosphere AF. The bearing ring 10 is heated until the ring 10 reaches a temperature of at least eight hundred forty degrees Celsius (840° C.), and preferably at least eight hundred seventy degrees Celsius (870° C.). Once the bearing ring 10 is heated to the desired temperature, nitrogen and carbon are introduced into the atmosphere A_{F} of the furnace F, preferably as ammonia gas G. The heating of the bearing ring 10 is continued at the desired minimum temperature for a predetermined period of time T_{CN}, preferably at least two hours. The carbonitriding process may be continuous or be conducted in a series of processes if sufficient amounts of ammonia in the furnace atmosphere A_{F} cannot be maintained in a single process.

While the bearing ring 10 is heated in the atmosphere A_{F} of nitrogen and carbon, a hardened case is formed on the outer surfaces of the ring 10 by the diffusion of these chemicals into the base steel. The case preferably has a depth of at least eight hundred microns (800 μ) as such a case depth allows the bearing ring 10 to be machined to final desired dimensions while permitting at least some casing to remain on the ring 10. However, the case depth may be lesser or greater than 800 μ depending on the required amount of machining or/and the desired amount of case on the finished bearing ring 10. In any case, after the carbonitriding process is complete and the bearing ring 10 has been quenched, the case typically has a hardness of about fifty-five to sixty hardness on the Rockwell C scale, or 55-60 HRc.

As a case hardness of 55-60 HRc makes machining of the bearing ring 10 generally difficult, the tempering process reduces the ring hardness to a level that facilitates the desired machining. Therefore, the bearing ring 10 is heated within the same or a different furnace F to reduce the hardness of the bearing ring 10 to a value that is preferably at or below thirty-five Rockwell hardness (35 HRc). In order to accomplish such a relatively substantial hardness reduction, the bearing ring 10 is heated to a temperature of at least four hundred twenty-five degrees Celsius (425° C.), preferably at least four hundred eighty degrees Celsius (480° C.) and most preferably between five hundred degrees Celsius (500° C.) and five hundred forty degrees Celsius (540° C.). The bearing ring 10 is held at this temperature for a tempering period TT of at least sixty minutes, and preferably for between 90-120 minutes. However, the tempering process may be conducted at any desired temperature and duration, a lower temperature typically requiring a greater duration, as long as the hardness of the bearing ring 10 is reduced to an appropriate hardness level.

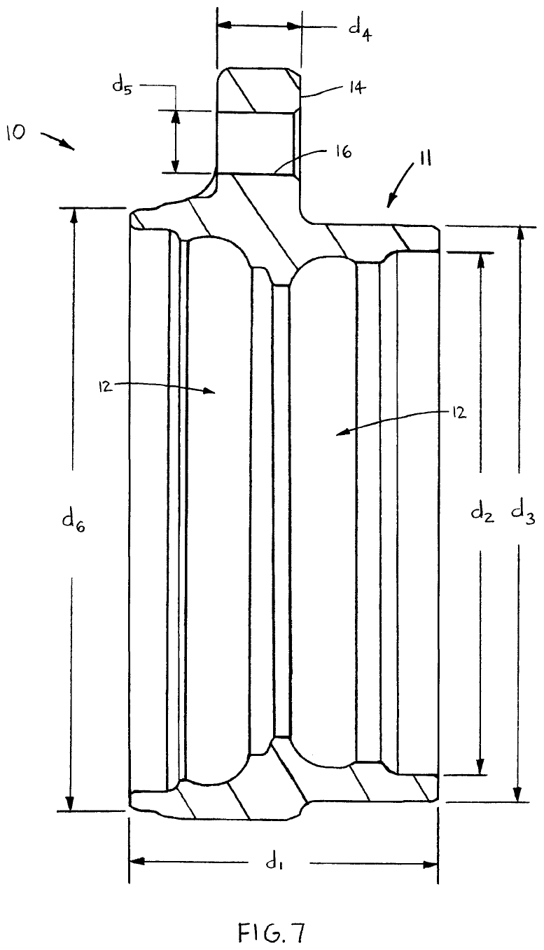

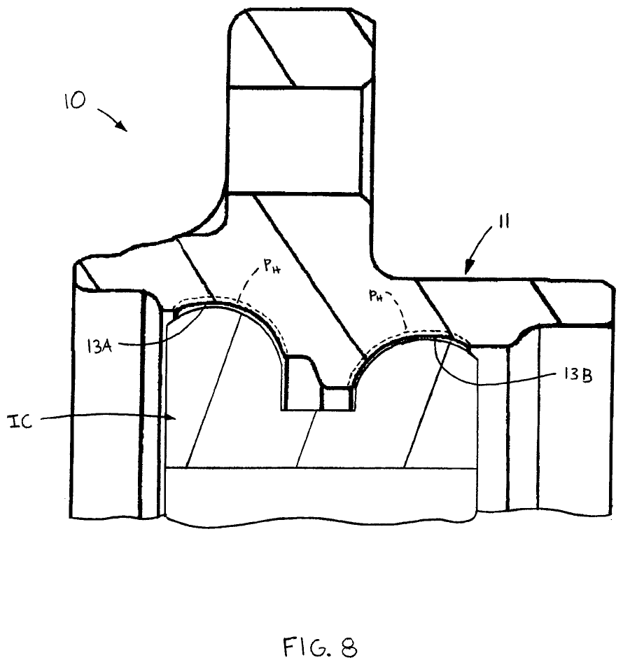

Once the bearing ring 10 has been tempered to reduce the hardness to a desired level, certain final dimensions d₁, d₂, d₃, d₄, d₅, d₆, etc. of the ring 10 are machined, some of which are indicated in FIG. 7. For example, with an outer ring 11, the dimensions include the outer ring axial length d1, the ring inside and outside diameters d₂, d₃, d₆, the mounting flange axial width d₄, the flange mounting hole inside diameter d₅, etc., although any other desired dimensions of the ring 10 may be machined at this point in the manufacturing process. After all such external machining is accomplished, the one or more raceway surfaces 12 are hardened to a desired value, preferably to at least a value of sixty on the Rockwell C scale (60 HRc). Preferably, the raceway surfaces 12 are hardened by means of an induction hardening process to localize the hardening to only the raceway surfaces 12 and adjacent portions p_{H} (FIG. 8) of the ring 10. Such an induction hardening process may be accomplished by means of a specially-designed inductor coil IC that is adapted to heat the raceway(s) 12 in a manner that restricts the hardening as desired, an exemplary depiction thereof being shown in FIG. 8.

If the raceway surface(s) 12 have a hardness greater than 62 HRc after induction hardening, the bearing ring 10 is preferably tempered a second time, most preferably by tempering the entire ring 10 in the same machine used for the induction hardening process, although another machine/furnace may be used and/or the raceway surface(s) 12 may be locally tempered. During the preferred second tempering step, the bearing ring 10 is heated to a temperature of no greater than three hundred degrees Celsius (300° C.) so as to retain residual compressive stresses within the bearing ring 10. That is, maintaining the temperature of the bearing ring 10 at or below 300° C. during the second tempering will prevent a complete removal or dissipation of residual compressive stresses within the raceway surfaces 12, which are beneficial in maximizing the fatigue life thereof. After the second tempering step, the bearing raceway surfaces 12 should have a hardness within the range of about 58-62 HRc.

Finally, after the raceway surfaces 12 are hardened to the desired level (and preferably tempered a second time), the raceway surfaces 12 are then finish machined to final dimensions and surface finish characteristics. Such finish machining includes grinding and honing the bearing raceway surface 12, and preferably involves two honing steps to achieve the desired surface finish. Thereafter, the bearing ring 10 may be assembled with the complementary bearing ring, i.e., the inner ring 2 if the bearing ring 10 is an outer bearing ring 11, and vice-versa, and one or more sets of rolling elements 3 to form the desired hub bearing unit 1, an exemplary embodiment of the hub bearing unit 1 being depicted in FIG. 1.

Due to the method of forming the bearing ring 10 as described in detail above, the raceway surfaces 12 of the hub bearing unit 1 have substantially increased resistance to brinelling during use. To illustrate this increased brinelling resistance, tests were conducted on a number of hub bearing units 1 having outer rings fabricated as follows: 1) outer ring with induction hardened raceways, 2) outer ring with carbonitriding only, and 3) outer ring formed in accordance with the present method. The various hub bearing units 1 were subjected to impacts sufficient to cause indentation of the raceway surfaces, and then the depth of each resulting indentation was measured.

The results of these tests are shown below:

The results shown in Tables 1 and 2 clearly show that the present process results in a substantially reduced indentation depth. To further explore the benefits of the present manufacturing method, tests were conducted on hub bearing units formed using standard manufacturing techniques and hub bearing units 1 made in accordance with the present method:

As can be seen by the data shown in Tables 3 and 4, the hub bearing units 1 which include bearing outer rings 11 formed using the manufacturing method of the present invention have a substantially reduced indentation depth when experiencing impacts in comparison with standard hub bearing units. The present manufacturing method has also been demonstrated to increase fretting wear resistance of the bearing outer ring 11. Further, although the bearing outer ring 11 is described as the primary focus of the present manufacturing method, the hub bearing unit 1 may alternatively be fabricated with both inner and outer rings 2, 11 formed in accordance with the method disclosed herein or with only the inner bearing ring 2 formed by the present method, particularly in bearing applications in which fretting wear is a substantial concern. Furthermore, although the present manufacturing method is described as applied to the fabrication of bearing outer rings, the method may be used to form bearing inner rings, plain bearings or other engineering components, such as gear teeth, valves, cams, joint surfaces, etc., with the induction hardening step being applied to critical surfaces, for example gear teeth contact surfaces, etc.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A method of manufacturing a wheel hub bearing unit, the method comprising the steps of:
providing a bearing ring having at least one raceway surface;
carbonitriding the bearing ring;
tempering the bearing ring;
induction hardening the at least one raceway surface of the ring; and
finish machining the at least one raceway surface of the bearing ring to desired final dimensions and surface finish.

2. The method as recited in claim 1 wherein:
the step of tempering the bearing ring is a first tempering step; and
the method further comprises a second tempering of the bearing ring after the step of induction hardening the at least one raceway surface of the ring, the bearing ring being heated to a temperature of no greater than three hundred degrees Celsius (300° C.) during the second tempering step so as to retain residual compressive stresses within the bearing ring.

3. The method as recited in claim 1 wherein the step of carbonitriding the bearing ring includes the substeps of:
placing the bearing ring within a furnace containing an enclosed atmosphere;
heating the bearing ring to at least eight hundred forty degrees Celsius (840° C.);
introducing nitrogen and carbon into the atmosphere of the furnace; and
continuing to heat the bearing ring within the furnace atmosphere for a predetermined period of time.

4. The method as recited in claim 3 wherein:
the sub step of introducing nitrogen and carbon includes introducing ammonia gas into the atmosphere of the furnace;
the sub step of continuing to heat the ring within the atmosphere of nitrogen and carbon includes heating the ring for at least two hours.

5. The method as recited in claim 1 further comprising the step of quenching the bearing ring after carbonitriding the bearing ring.

6. The method as recited in claim 1 wherein the step of providing the bearing ring includes the substeps of:
forging the bearing ring; and
machining at least certain dimensions of the bearing ring to an approximate desired final dimension.

7. The method as recited in claim 1 wherein the step of providing the bearing ring includes providing a ring formed of a steel having a carbon content of between about 0.55% by weight and 0.60% by weight.

8. The method as recited in claim 1 wherein the step of tempering the bearing ring includes reducing the surface hardness of the ring to about or below thirty-five Rockwell hardness (35 HRc).

9. The method as recited in claim 1 wherein the step of tempering the bearing ring includes heating the ring to at least five hundred degrees Celsius (500° C.) for at least sixty minutes.

10. The method as recited in claim 1 wherein the step of finish machining the raceway surface of the bearing ring includes grinding and honing the bearing raceway surface.

11. The method as recited in claim 1 wherein the step of induction hardening the raceway includes heating the raceway using an induction coil.

12. The method as recited in claim 1 further comprising the step of machining each one of certain dimensions of the bearing ring to desired final dimensions before the step of induction hardening the raceway of the bearing ring.

13. The method as recited in claim 1 wherein the step of providing the bearing ring includes providing a ring having two raceway surfaces and at least one mounting flange.

14. A method of manufacturing a wheel hub bearing unit, the method comprising the steps of:
providing a bearing ring having at least one raceway surface, the bearing ring being formed of a steel having a carbon content of between about 0.55% by weight and 0.60% by weight;
carbonitriding the bearing ring within a furnace having an enclosed atmosphere containing ammonia gas;
tempering the bearing ring by heating the bearing ring to at least four hundred twenty-five degrees Celsius (425° C.);
induction hardening the at least one raceway surface of the bearing ring;
tempering the bearing ring after induction hardening the at least one raceway surface by heating the bearing ring to a temperature no greater than three hundred degrees Celsius (300° C.) so as to retain residual compressive stresses within the bearing ring; and
machining the at least one raceway surface of the bearing ring to desired final dimensions and surface finish.

15. The method as recited in claim 14 wherein the step of carbonitriding the bearing ring includes the substeps of:
placing the bearing ring within a furnace containing an enclosed atmosphere;
heating the bearing ring to at least eight hundred forty degrees Celsius (840° C.);
introducing the ammonia gas into the atmosphere of the furnace; and
continuing to heat the bearing ring within the furnace atmosphere for a predetermined period of time of at least two hours.

16. The method as recited in claim 14 wherein the step of providing the bearing ring includes the substeps of:
forging the bearing ring; and
machining at least certain dimensions of the bearing ring to an approximate desired final dimension.

17. The method as recited in claim 14 wherein the step of providing the bearing ring includes providing a ring formed of a steel having a carbon content of between about 0.55% by weight and 0.60% by weight.

18. The method as recited in claim 14 wherein the step of tempering the bearing ring includes reducing the surface hardness of the ring to about or below thirty-five Rockwell hardness (35 HRc).

19. The method as recited in claim 14 wherein the step of tempering the bearing ring includes heating the ring to at least five hundred degrees Celsius (500° C.) for at least sixty minutes.

20. A wheel hub bearing unit comprising:
a bearing inner ring;
a bearing outer ring, at least one of the inner ring and the outer ring being formed of a medium carbon steel, the medium carbon steel having a carbon content of between about 0.55% by weight and 0.60% by weight, and having at least one raceway, the at least one ring being carbonitrided and the at least one raceway surface being induction hardened after carbonitriding the at least one ring; and
a plurality of rolling elements rotatably coupling the bearing inner ring and the bearing outer ring.
